(19) United States
(12) Patent Application Publication
(10) Pub. No.: US 2013/0325547 A1
(43) Pub. Date: Dec. 5, 2013

(54) Calculating the Value Contributed by Physical Stores to a Mobile Device User Who Makes a Subsequent Online Purchase and Potentially Distributing that Value Calculation to Either Physical Stores the User or Both

(71) Applicant: Miles Newbold Clark, New Orleans, LA (US)

(72) Inventor: Miles Newbold Clark, New Orleans, LA (US)

(21) Appl. No.: 13/874,466

(22) Filed: Apr. 30, 2013

Related U.S. Application Data
(60) Provisional application No. 61/641,743, filed on May 2, 2012.

(51) Int. Cl. G06Q 30/02

(52) U.S. Cl. CPC G06Q 30/0201
USPC 705/7.29

(57) ABSTRACT

A method is disclosed for calculating the “experiential value” a physical store provides toward a consumer's subsequent online purchase. The method is embodied in a computer program or series of computer programs, available from a web portal linked to a server, which store relevant information for a consumer, a physical store, and an online store; track the physical location of a consumer's electronic mobile device; compare the device's location against the locations of physical stores and saves any positive comparisons; track the mobile device user's subsequent online purchases; compare any subsequent online purchase to the data on record for the physical stores previously visited by the user; perform a series of calculations to estimate any previously visited physical store's contribution to the user's subsequent online purchase; and translate that value into a monetized or monetizable form which can be returned to the physical store, the user, or both.

### CROSS-REFERENCE TO RELATED APPLICATIONS

Current application claims May 2, 2012 filing date from provisional No. 61/641,743

### STATEMENT REGARDING FEDERALLY SPONSORED RESEARCH OR DEVELOPMENT

Not Applicable.

### NAMES TO PARTIES TO JOINT RESEARCH AGREEMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Technical Field

The present invention relates to the field of computers, and demarcates a method for tracking, transmitting, and compiling data over a computer network from and to a user, physical store and online store, deriving a “value” from the compilation. The desired inputs for deriving this “value” are a user's physical presence in a store, certain store data or comparative data collected from the time a user is present until sometime shortly thereafter, and a user's subsequent online purchase. These desired inputs are intended as one illustration of the method, but are not the exclusive illustration of the method.

2. Description of the Related Art—in General

The internet has become increasingly important as a medium for conducting commercial activity, including the exchange of goods. Consequently, the percentage of goods transactions taking place in “brick and mortar” or “physical” stores has suffered, particularly in the retail sector (retail shopping will be used as a non-inclusive illustration for the remainder of this description). The decrease in physical retail shopping experiences, particularly among middle-class consumers, has had significant economic consequences. These include increased vacancies in shopping malls and “downtown” stopping areas, high-profile bankruptcy filings of chain stores such as Circuit City and Border's, and an overall drop in retail hiring.

The shift to online transactions has resulted from several factors. First, the accessibility and normalization of online marketplaces has grown exponentially over the past fifteen years. Second, consumers, particularly younger consumers who have “grown up” on the internet, are now more accustomed to conducting an increasing number of life activities on computers and the interne, including purchasing goods. Third, and most importantly for purposes of this Specification, prices from Online Stores will inevitably remain more competitive than those at physical stores for many items, due to the fact that online stores have, in general, significantly lower labor and facilities costs, and have the ability to stock more goods and present more strategic “loss leaders.” The fundamental superiority in competitiveness as a function of overhead and product availability will remain, even if, for example, increased legislative efforts in the U.S. Congress to more effectively streamline and tax transactions of online retailers are ultimately enacted into law.

The competitive erosion of physical stores has occurred most significantly for products whose “experiential” value is low, such as books and electronics. For other classes of goods, such as clothing, the “experiential” value of the ultimate purchase is far higher, because such goods are normally touched and modeled by the purchaser. Regardless of the experiential value, however, little prevents a person from entering a physical store, sampling the desired goods, and then searching the internet for a more competitive price. Traditional sales strategies, such as “price-matching,” are increasingly unfeasible given the overwhelming competitive superiority of online stores.

Moreover, the issues of online competition are not evenly distributed. Large companies, such as Gap and JCrew, operate physical stores and also offer their goods for sale online through their websites. Such “hybrid” companies likely lose less overall business by providing customers a means of ordering their goods online, and may view their stores as “loss leaders” designed to improve the standing of the brand. However, such “chain” stores are typically found in large cities and suburbs, and do not exist in smaller towns whose total consumer activity cannot support such “chain” stores. As a result, smaller towns are witnessing an unprecedented decimation of their downtown shopping areas. This will have deleterious effects on the overall fabric of society; as people spend more and more time on the internet and in various online communities, there will likely be an increased demand for “main streets” to provide pleasant walkable community spaces as a means of escape.

It is a cruel irony that at the very time when society may need physical commercial experiences to fill a psychological void, these experiences are increasingly divested of their means of economic buoyancy. And while physical stores which customers visit undoubtedly play a role in many subsequent online purchases by, in the case of clothing purchases, permitting customers to browse the shelves use their fitting rooms, and otherwise “experience” the goods prior to purchase, to the inventor's knowledge there appears no means of valuing the physical store's “contribution” to the purchase, much less compensating it in kind. Therefore, although the store has paid its rent and utility bills and its employees, online merchants collect all of the profit from a more competitively priced online transaction.

The embodiments described herein provide a means of leveling the playing field between physical and online merchants by tracking, quantifying, valuing, and ultimately monetizing the time a mobile device user spends in a physical store. They also provide incentive for the user to share in some percentage of the valuation. These embodiments will do more than help ensure the financial survival Main Streets, however; they will also provide a viable means of making larger “hybrid” brands available to consumers in small towns. Consumers in small towns whose stores cannot withstand online competition will confront far higher transaction costs in the form of traveling to a location where the goods can be experienced; these users may ultimately devalue the “experiential” quality of goods to a greater extent than consumers who live in high-density areas. Once consumers devalue the “experiential” quality of the goods, there is a greater likelihood that they will conduct more of their commercial transactions online. A company's success in a competitive market depends on product placement, which in turn hinges on having a distribution chain; however, purchasers who turn to the online marketplace divest large “hybrid” companies with established brands of their natural physical distribution advantage, as well as their ability to contextually establish their “status” by, for example, renting out a storefront in an high net worth area. Tellingly, studies show that younger consumers who have “grown up” with the internet demonstrate less affinity for a particular brand and are more inclined to choose products based on price. Therefore, without some means of maintaining the “experiential” status quo in smaller markets, even established “hybrid” companies stand to lose considerable market share.

Clearly, physical retail business does not cease in smaller communities which lose their small independent retail businesses. However, the environment created is often unfavorable for many brands. Typically in such communities, large retail stores such as Wal-Mart have assumed primary roles as merchants due to their superior ability to create extensive and efficient distribution networks. However, it is likely that many brands would elect not to place their products in such stores, not only because of the considerable reduction in bargaining power when dealing with a virtually monolithic retailer, but also because such large retail stores would, by virtue of their competitive pricing, be seen as “damaging” the “class status” of many brands.

Because goods markets vary with respect to geography, goods, consumer “experiences” and other variables, the preferred embodiment permits flexibility in the range of usable inputs for the calculation of the “experiential value.” For example, a large “hybrid” store which maintains a physical store in a certain area may wish to directly compete with independent retailers within a certain geographical radius of its own store, and may reduce or eliminate the percentage of the valuation pertaining to stores carrying identical or similar identifiable product characteristics (such as a UPC Code). At the same time, in geographical areas where a “hybrid” store does not maintain a physical presence, that “hybrid” store could permit or increase the percentage of the valuation for stores carrying a good with the same or similar product characteristics.

Moreover, the preferred embodiment can be used as more than a method to facilitate remission of payment between two or more distinct business entities. Because step (6) and step (7) involve, in part, transfer of either a monetized or monetizable valuation of the user's physical presence, businesses could use the method to simply return a valuation or a calculation of that valuation in terms of the total purchase price, which permits analysis without transfer of a monetized payment. Large “hybrid” merchants are no less aware of the financial complications inherent in maintaining a physical presence in the form of a store, and so could employ the methods herein in their own stores to merely quantify the “experiential value” of user physical presence, to better determine which stores were over- or under-performing, and how to adjust their business model to better reflect the “experiences” most valued by consumers. Because the method combines the locator function of a user's mobile device with a flexible range of variables, it provides a superior and more particularized stream of data on individual user behavior. The analytical capabilities of the method would be especially useful for “franchised” stores which are independently owned, but for which a franchise is typically “awarded” only after considerable efforts to analyze the potential market impact of adding another store, and for stores seeking to determine what aspects of their individual business models factor most into a consumer's “experiential value.”

The embodiments are envisioned to work with existing invoicing systems used by goods merchants, because they will filter stores by a commonly used product identifier, such as the universal product code (UPC Code) of a good. The UPC code is preferred because it is affixed to all, or virtually all, goods sold in this country, and almost certainly appears on most, if not all, invoicing systems used. Even if programming the required computer applications used in the preferred embodiment for full automation with the plethora of distinct invoicing systems proves challenging, the fact that step (6) and step (7) involve transfer of either a monetized or monetizable valuation of the user's physical presence means that a “general” invoice reflecting the valuation could be generated by the application, stored on a server, and viewed on a web portal by the user, physical store, and online store, or some combination of the same. This information could ultimately be used for manual or semi-manual remission of valuation percentages allocated to either the user or physical store. When performing this non-automated monetized invoicing of valuations, the physical store and online store will be able to “work” off of the “general” invoice generated by the program.

3. Description of the Related Art—Specific

Certain attempts to automate transactions performed on through mobile devices have recently appeared elsewhere. For example, American Express, a credit card company, has developed a mobile device application which allows users to “swipe” their physical credit cards through a portable card reader linked to the user's mobile phone, so as to facilitate immediate purchase of an item. To the inventor's knowledge, the American Express concept does not provide any link between the transaction and the physical environment, let alone a return a valuation of the user's presence. With even more limited goals, other companies have developed applications which allow a store to “view” the user profiles of mobile device users in their stores, and another company, Google, has recently developed interactive wearable mobile devices which track a user's location and provide certain information about the user's surrounding environment. These concepts, and many others, are all premised on utilization of a “locator” function typically installed into mobile devices; to the inventor's knowledge none of the current methods involving a “locator” function actually seek to use the location of a user's mobile device as the starting-point for a valuation of the “experiential” elements of physical presence which factor into a subsequent purchase, much less providing a vehicle for remitting a percentage of that value calculation to one or several physical stores and/or the user.

Finally, other businesses have recently created mobile applications which register a mobile device user's presence in a specified physical store and calculate a “value” for the user's presence in the form of rebates, rewards points, or other monetizable forms. This set of concepts is more limited than the current system and method, insofar as they comprise an entirely “closed loop” system where a mobile device user's activity is tracked only by that particular store or “chain” of stores, and the “experiential value” of the user's presence in that store is calculated only in relation to future purchase of that particular store's products. The system and method described herein is fundamentally different from such business methods, as its preferred embodiment takes into account the fact that the “experiential value” of a user's presence may be compared between different merchants, and presupposes not only that a subsequent online purchase will be made, but further that this subsequent online purchase may be transacted with an entirely different merchant than the merchant or merchants whose physical stores contributed generate the user's “experiential value.” Building from this, the system and method described herein provides a means of apportioning the “experiential value” between all interested merchants in the transaction, as well as the user.

### BRIEF SUMMARY OF THE INVENTION

A method, embodied in a computer program or series of computer programs, available from a web portal linked to a server, which is installed on a user's internet-capable mobile device and/or other internet-capable device, which (1) tracks the device user's physical presence in physical stores, (2) saves the store's inventory at the time the user is physically present in the physical store, (3) tracks the user's subsequent online purchases, (4) compares the inventory lists or other lists of a user's tracked physical stores against the user's list of online purchases and creates a list of “matched” stores, (5) calculates the “value” of the user's time in the “matched” and/or “unmatched” stores against one or several variables, (6) compares all or a percentage of this valuation against a user's subsequent online purchase and converts the comparison into a monetized or monetizable form, and (7) remits all or a percentage of the monetized or monetizable valuation to either the user, the physical store, or both.

### BRIEF DESCRIPTION OF THE SEVERAL VIEWS OF THE DRAWING

Attached to this application hereto are rough drawings of the preferred embodiment, which give a general sketch of how different parts of the method work together. These drawings are consecutively numbered for each step of the preferred embodiment. Each of the forty “Figures” corresponds to a different enumerated step and step-subset in the preferred embodiment which appears directly above said drawling. One exception to this general rule is step (5); because step (5) is meant as an illustration of a single calculation, a great number of steps were better represented in a combined drawing, and so was represented in only two “Figures.” Moreover, due to logistical concerns some of the “non-live” boxes in step (7), step-subset (5) were omitted.

Please note that access to the internet is assumed in all drawings and has not been represented. Also note that arrow lines have been provided when necessary. Also note that in almost every case, the boxed text elements used to describe each sub-part of each step build cumulatively from the beginning to the end of the step; the borders of boxed text elements have been widened from 0.75 width to 1.50 width when describing a “live” element in the depicted step-subset.

FIG. 1 correlates with step (1), step-subset (1), step-sub-subset (a) of the preferred embodiment.

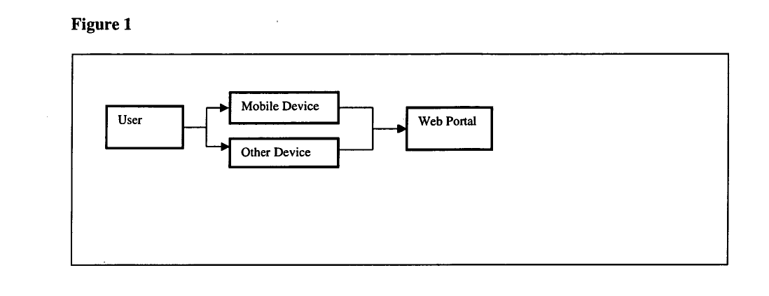

FIG. 2 correlates with step (1), step-subset (1), step-sub-subset (b) of the preferred embodiment.

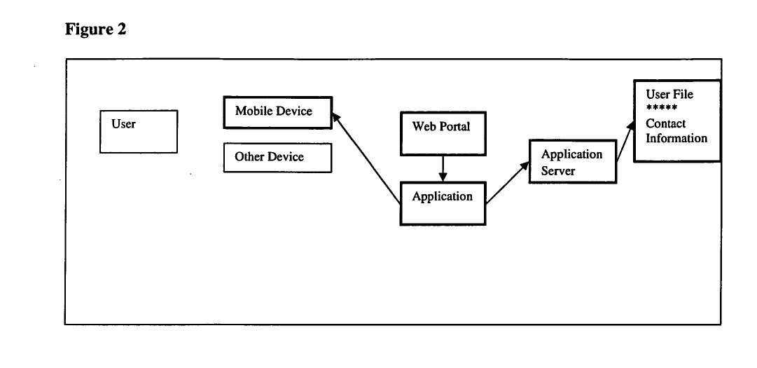

FIG. 3 correlates with step (1), step-subset (1), step-sub-subset (c) of the preferred embodiment.

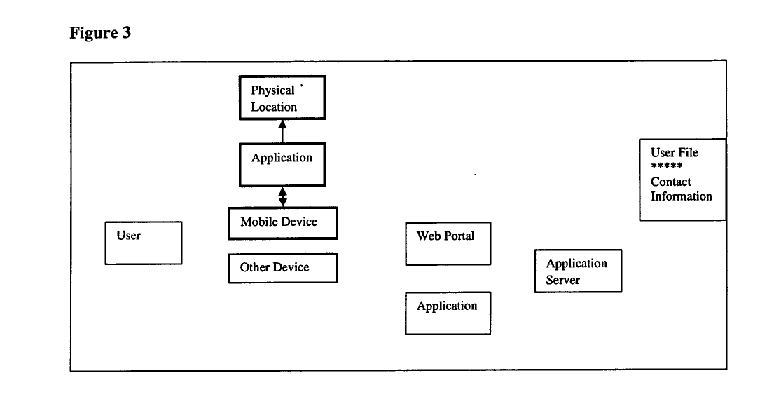

FIG. 4 correlates with step (1), step-subset (1), step-sub-subset (d) of the preferred embodiment.

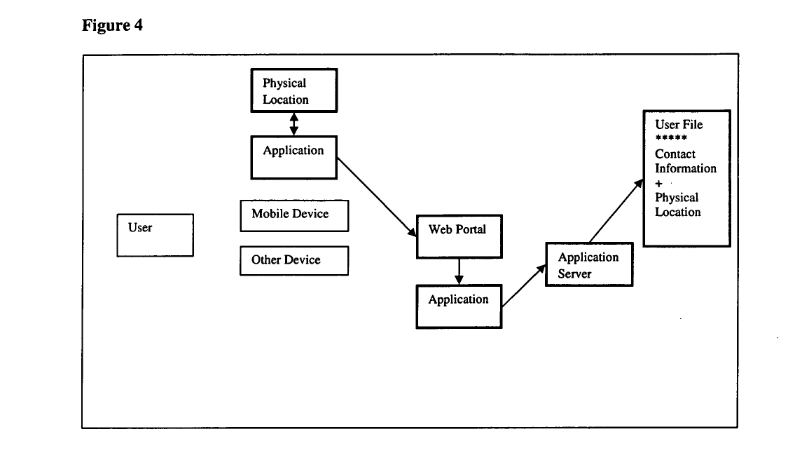

FIG. 5 correlates with step (1), step-subset (2), step-sub-subset (a) of the preferred embodiment.

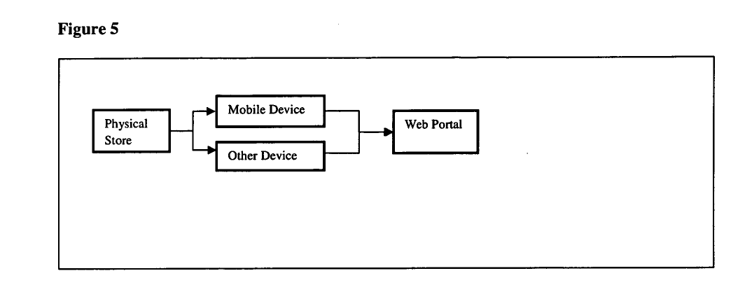

FIG. 6 correlates with step (1), step-subset (2), step-sub-subset (b) of the preferred embodiment.

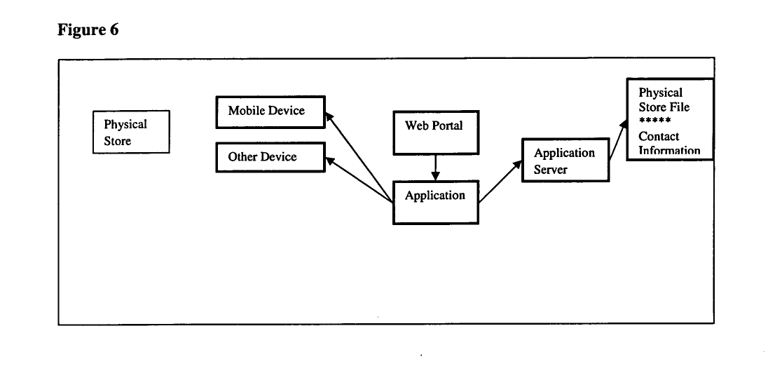

FIG. 7 correlates with step (1), step-subset (2), step-sub-subset (c) of the preferred embodiment.

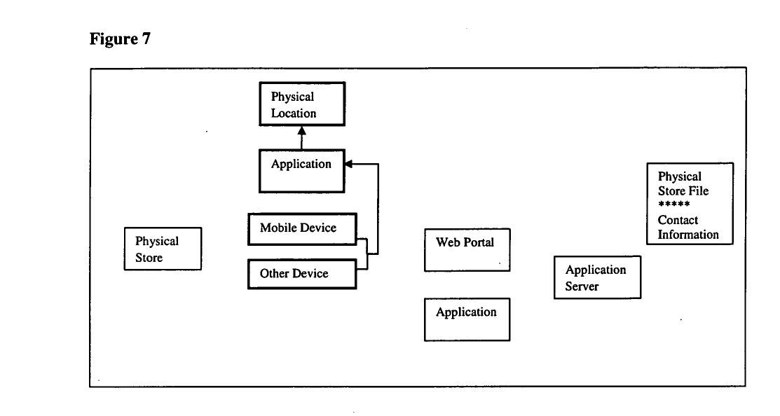

FIG. 8 correlates with step (1), step-subset (2), step-sub-subset (d) of the preferred embodiment.

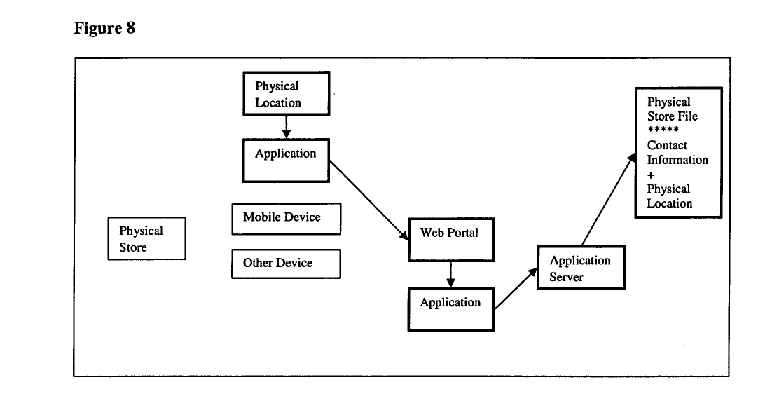

FIG. 9 correlates with step (1), step-subset (2), step-sub-subset (e) of the preferred embodiment.

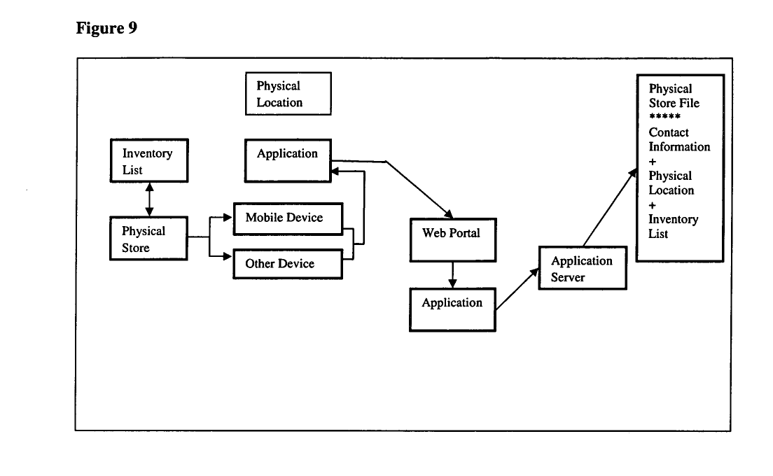

FIG. 10 correlates with step (1), step-subset (2), step-sub-subset (f) of the preferred embodiment.

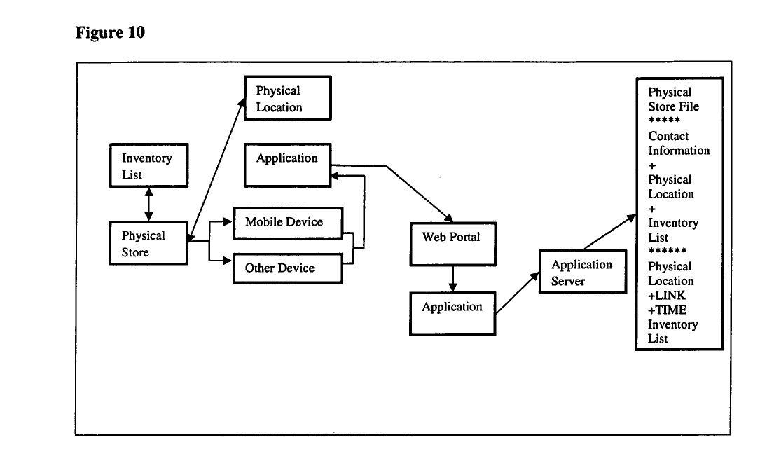

FIG. 11 correlates with step (1), step-subset (3), step-sub-subset (a) of the preferred embodiment.

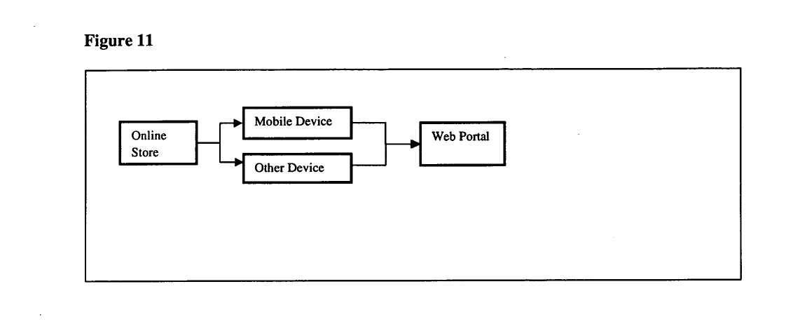

FIG. 12 correlates with step (1), step-subset (3), step-sub-subset (b) of the preferred embodiment.

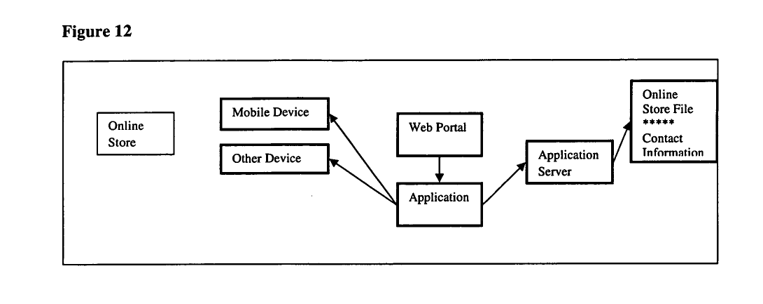

FIG. 13 correlates with step (1), step-subset (3), step-sub-subset (c) of the preferred embodiment.

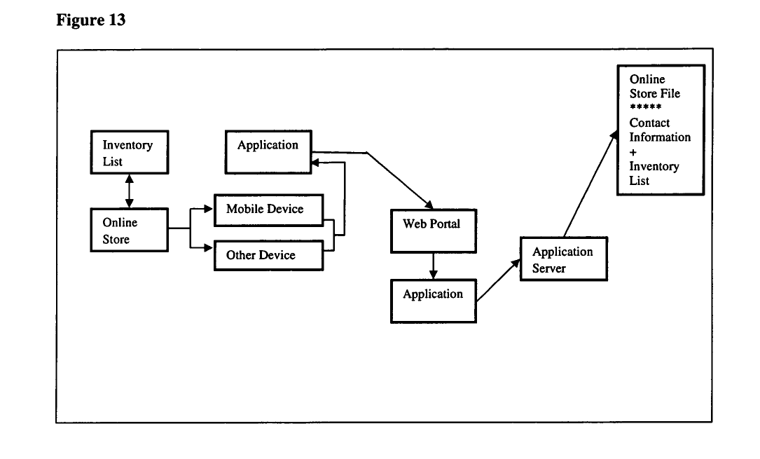

FIG. 14 correlates with step (1), step-subset (3), step-sub-subset (d) of the preferred embodiment.

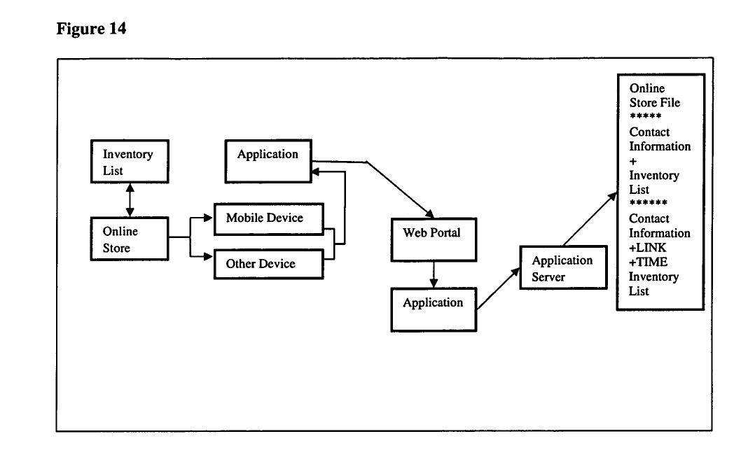

FIG. 15 correlates with step (2), step-subset (1) of the preferred embodiment.

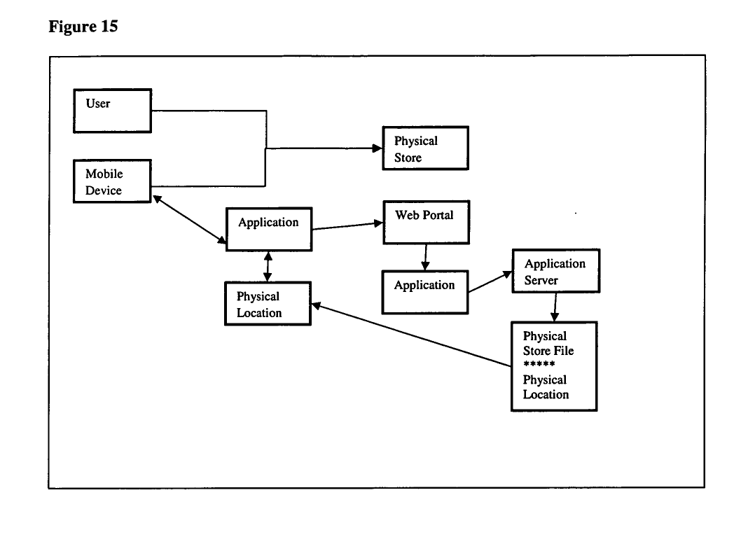

FIG. 16 correlates with step (2), step-subset (2) of the preferred embodiment.

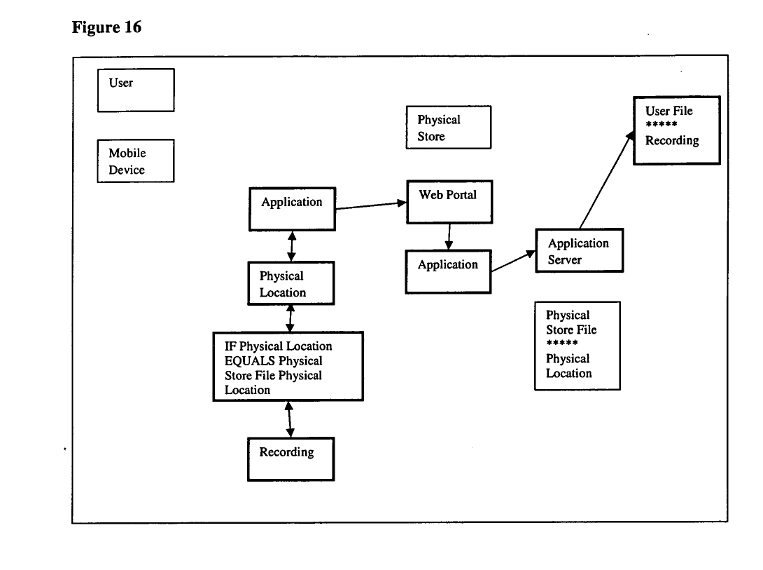

FIG. 17 correlates with step (2), step-subset (3) of the preferred embodiment.

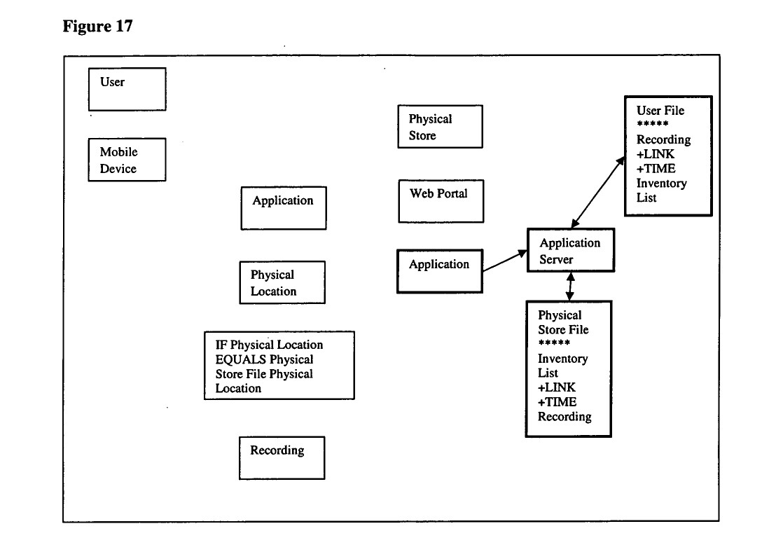

FIG. 18 correlates with step (2), step-subset (4) of the preferred embodiment.

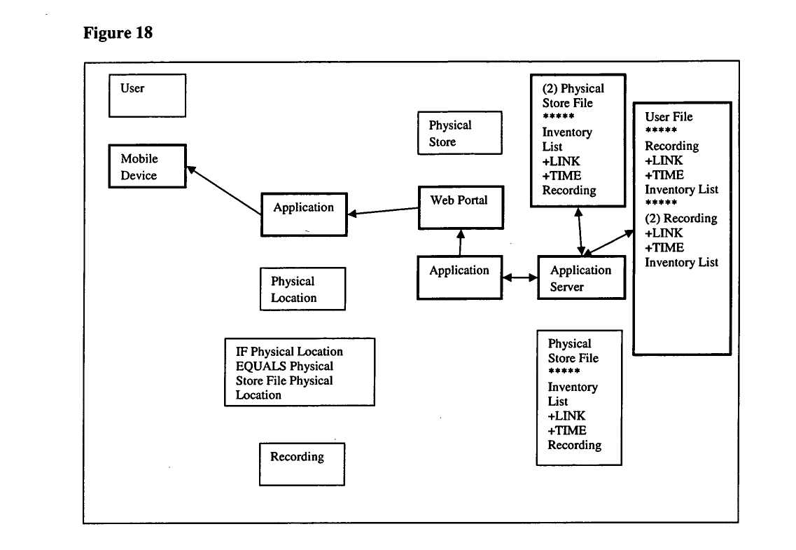

FIG. 19 correlates with step (3), step-subset (1) of the preferred embodiment.

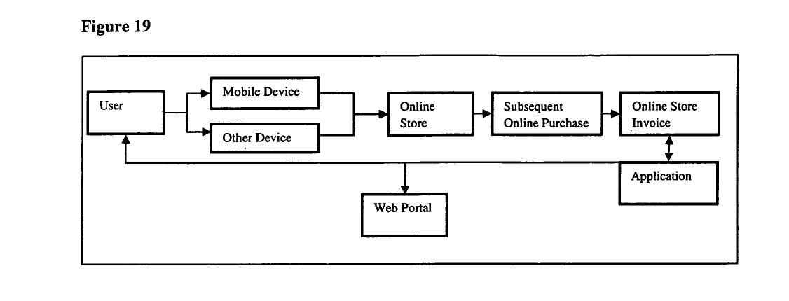

FIG. 20 correlates with step (3), step-subset (2) of the preferred embodiment.

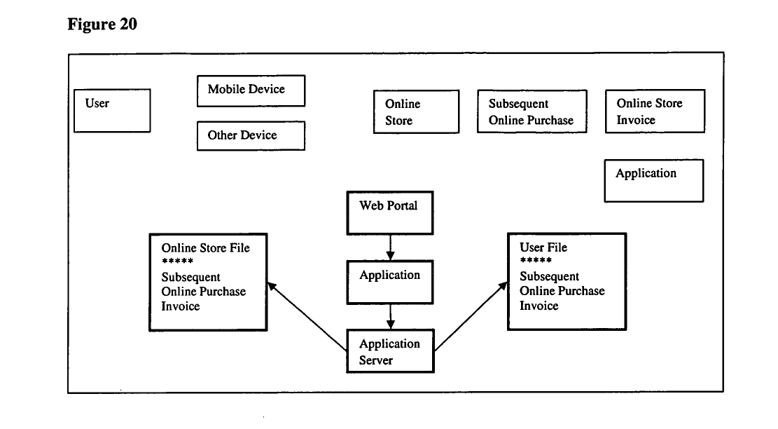

FIG. 21 correlates with step (4), step-subset (1) of the preferred embodiment.

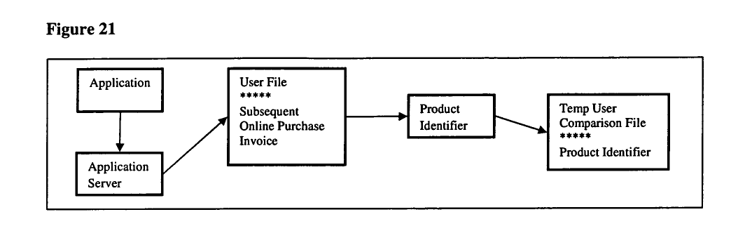

FIG. 22 correlates with step (4), step-subset (2) of the preferred embodiment.

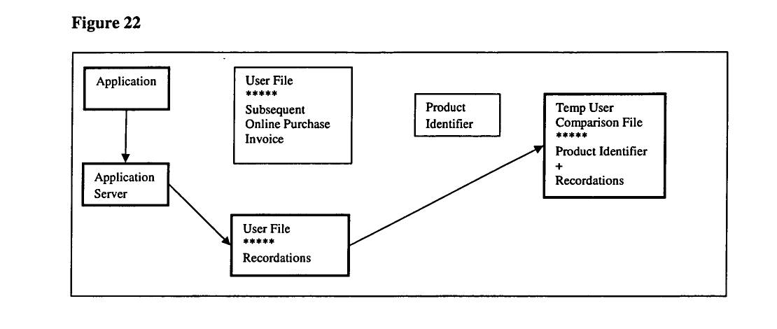

FIG. 23 correlates with step (4), step-subset (3) of the preferred embodiment.

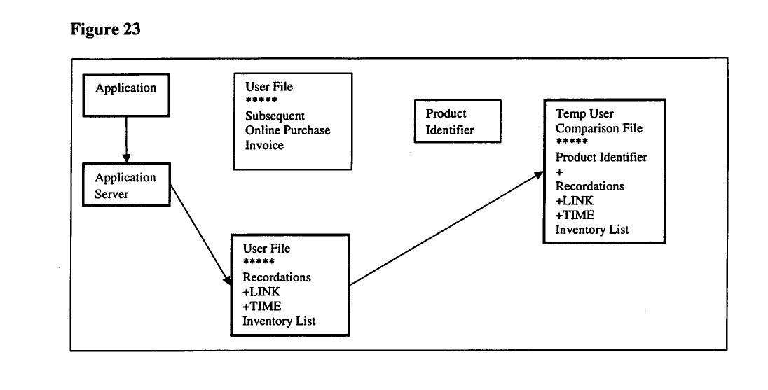

FIG. 24 correlates with step (4), step-subset (4) of the preferred embodiment.

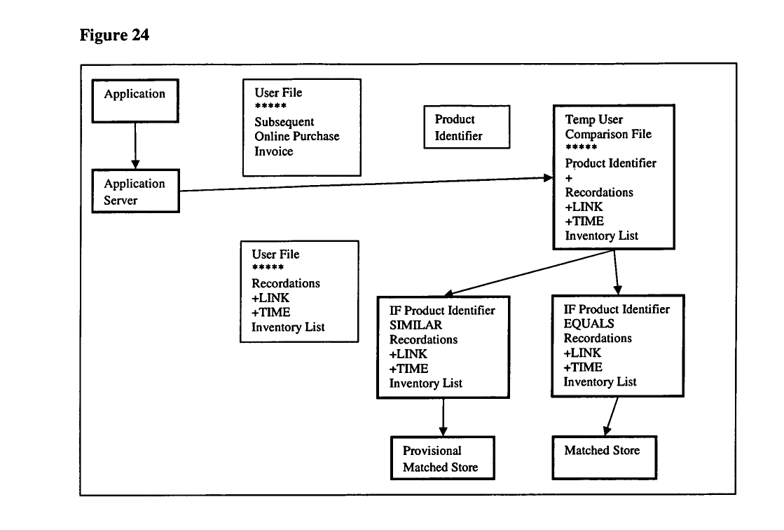

FIG. 25 correlates with step (4), step-subset (5) of the preferred embodiment.

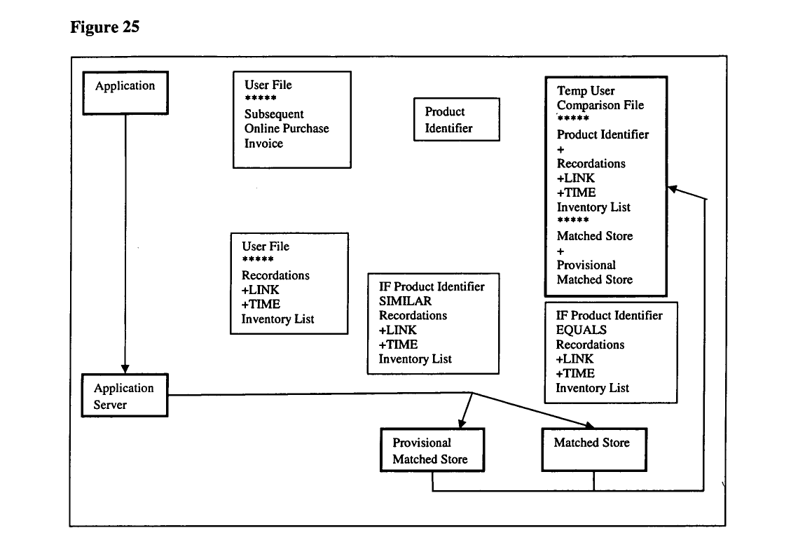

FIG. 26 correlates with step (4), step-subset (6) of the preferred embodiment.

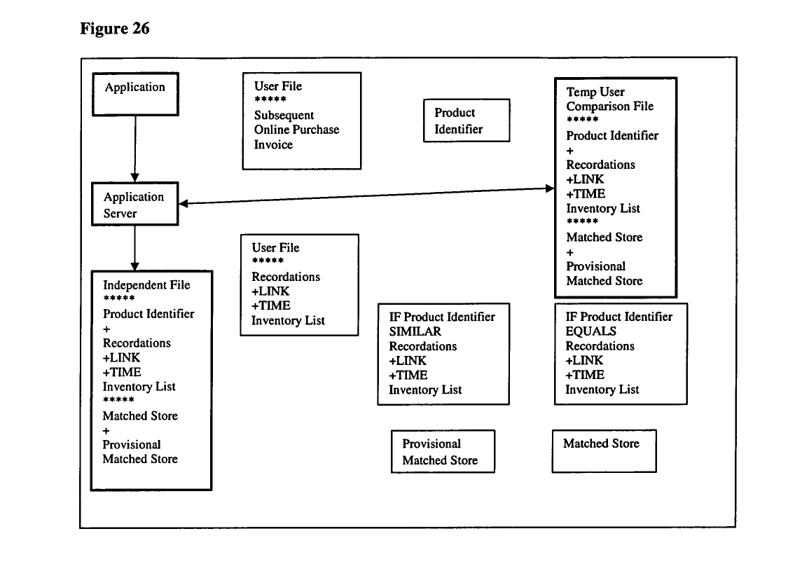

FIG. 27 correlates with step (5), step-subset (1) of the preferred embodiment.

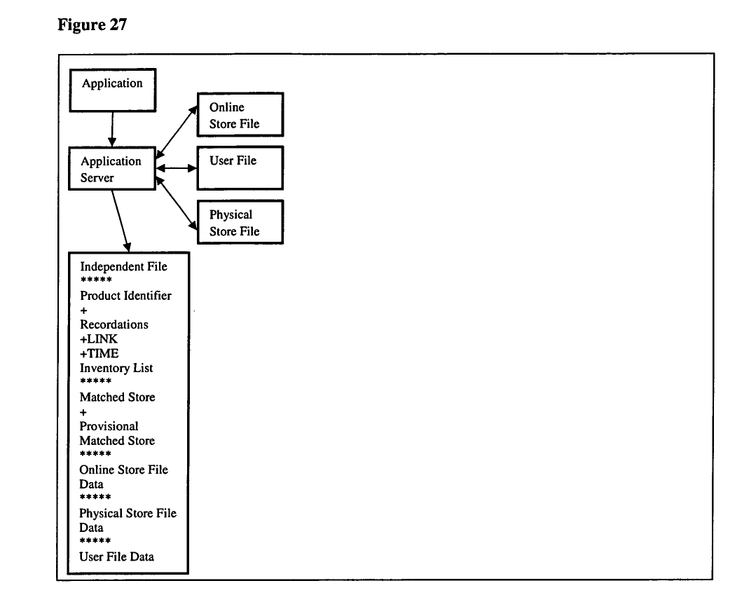

FIG. 28 correlates with step (5), step-subset (2)(I)-(VI) of the preferred embodiment.

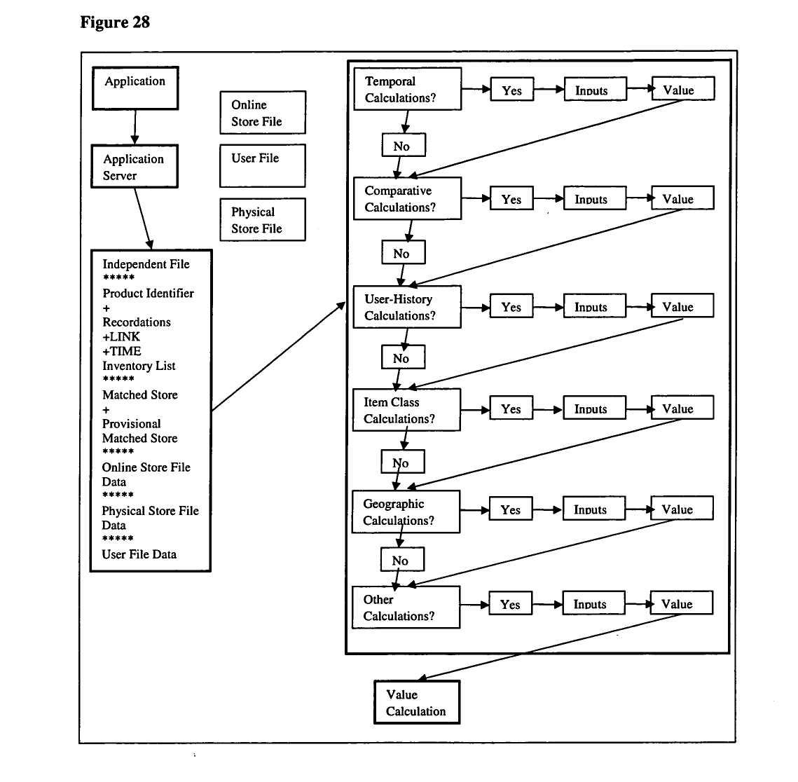

FIG. 29 correlates with step (6), step-subset (1) of the preferred embodiment.

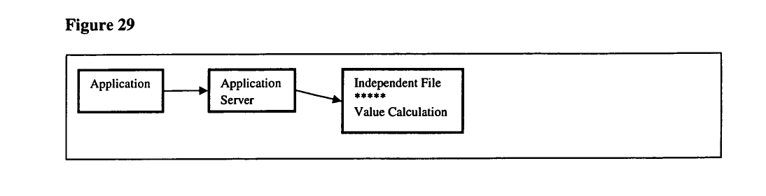

FIG. 30 correlates with step (6), step-subset (2) of the preferred embodiment.

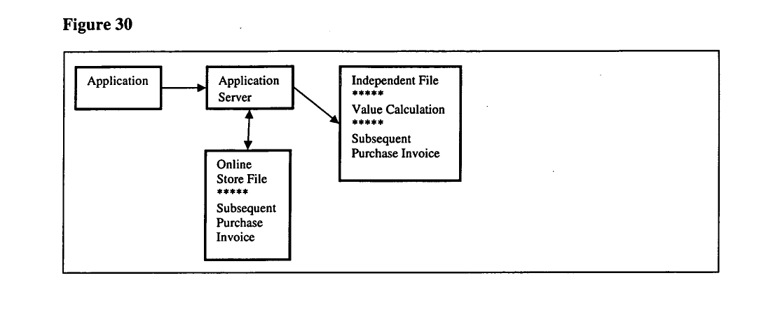

FIG. 31 correlates with step (6), step-subset (3) of the preferred embodiment.

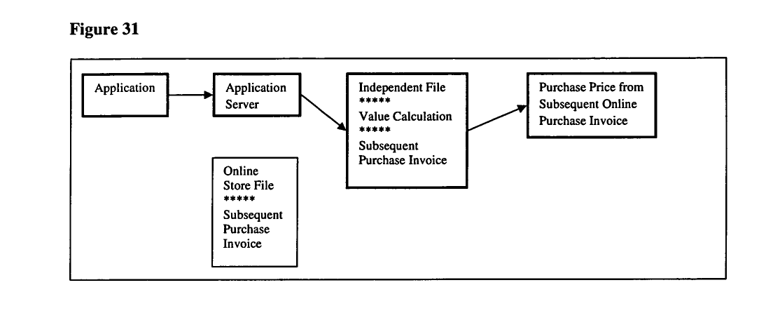

FIG. 32 correlates with step (6), step-subset (4) of the preferred embodiment.

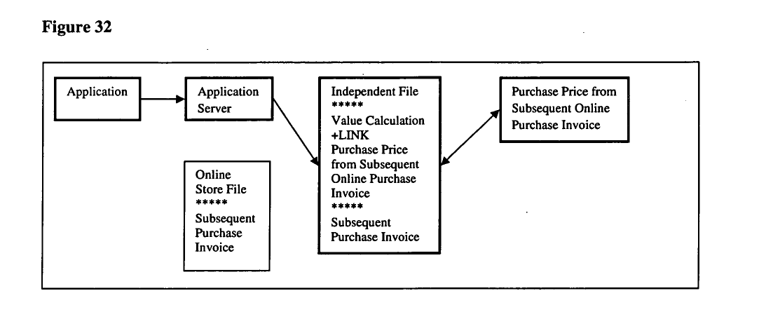

FIG. 33 correlates with step (6), step-subset (5) of the preferred embodiment.

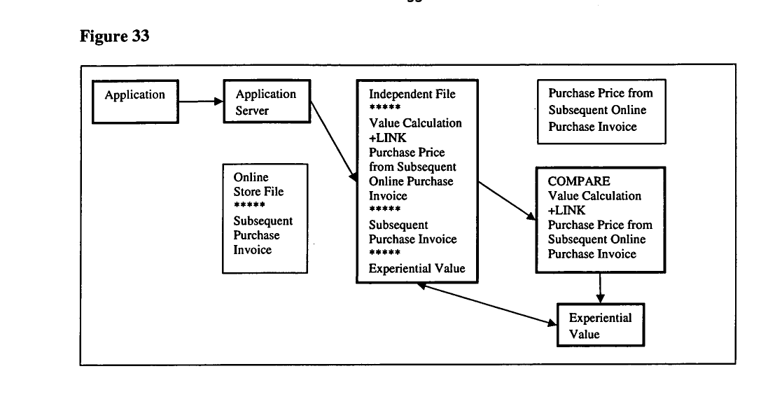

FIG. 34 correlates with step (6), step-subset (6) of the preferred embodiment.

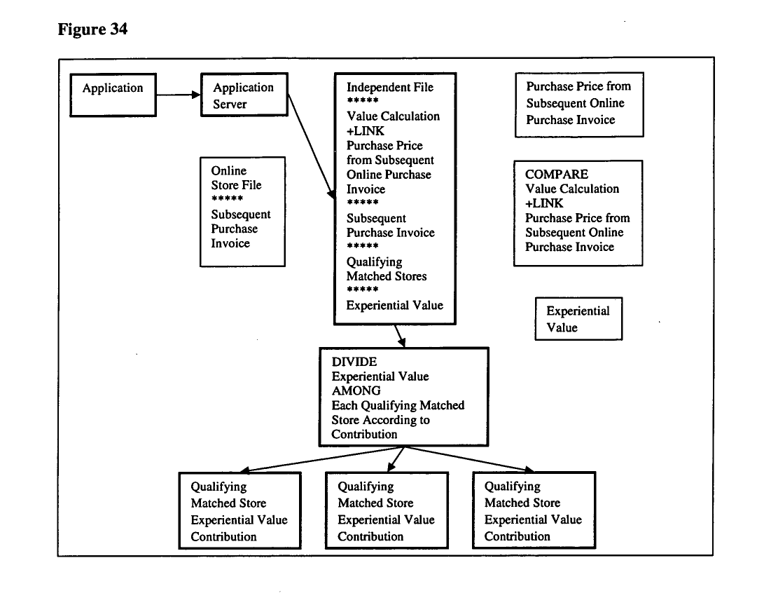

FIG. 35 correlates with step (6), step-subset (7) of the preferred embodiment.

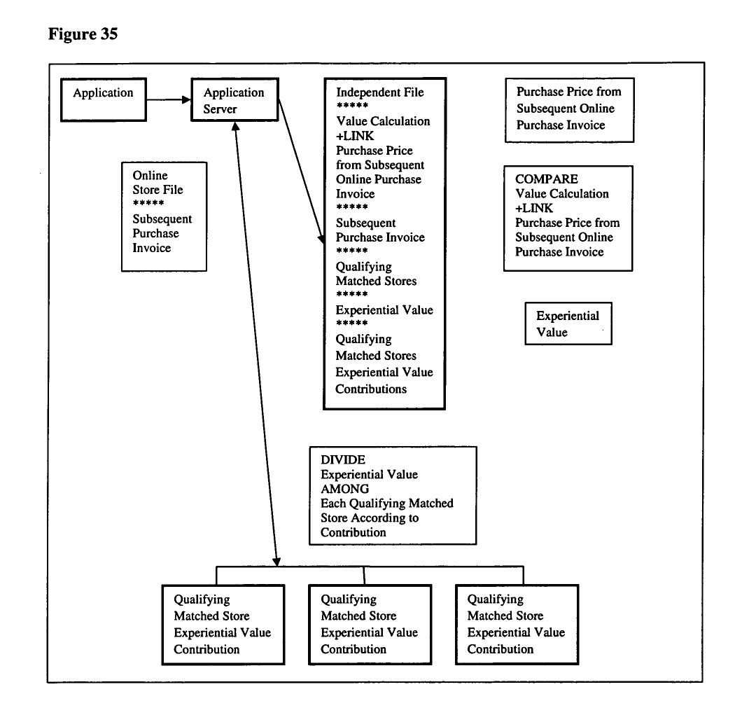

FIG. 36 correlates with step (7), step-subset (1) of the preferred embodiment.

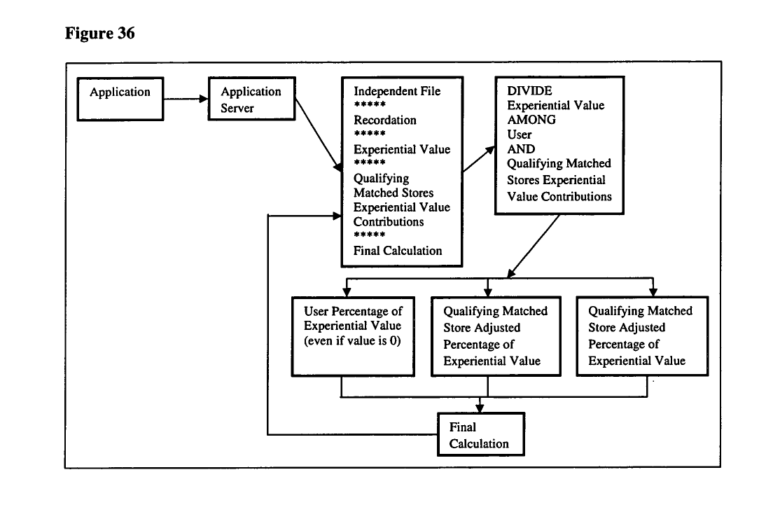

FIG. 37 correlates with step (7), step-subset (2) of the preferred embodiment.

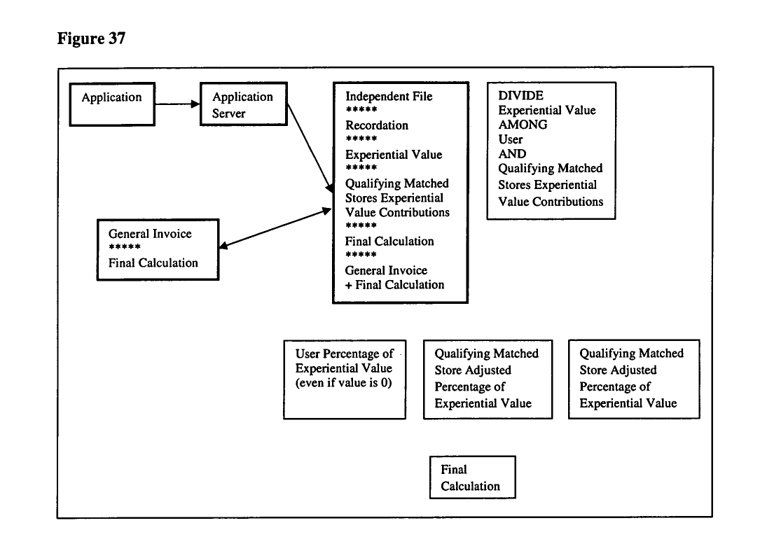

FIG. 38 correlates with step (7), step-subset (3) of the preferred embodiment.

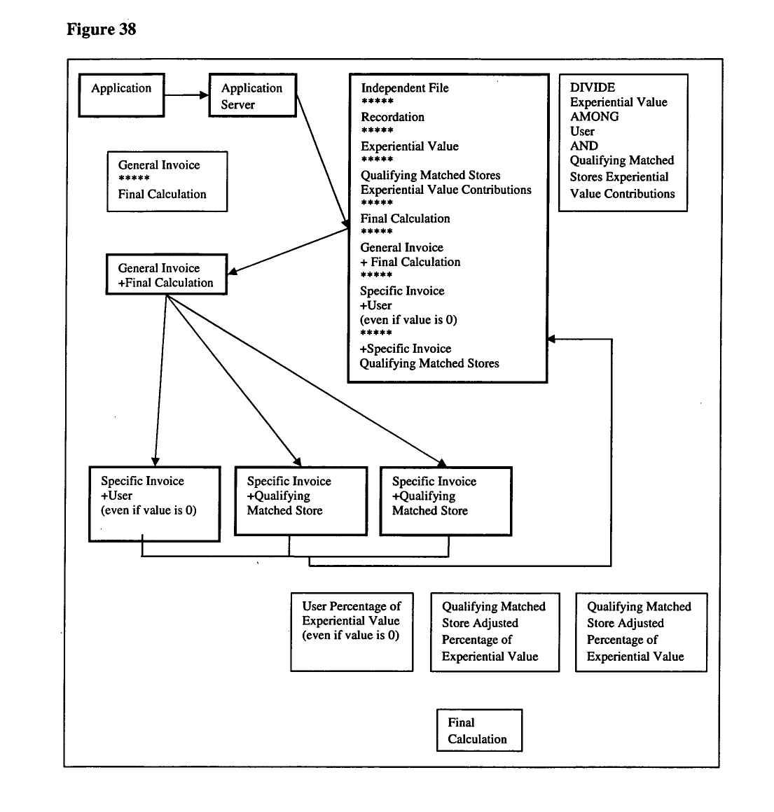

FIG. 39 correlates with step (7), step-subset (4) of the preferred embodiment.

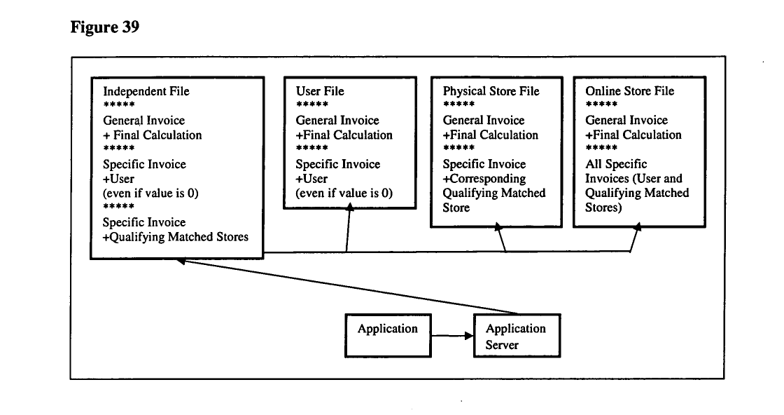

FIG. 40 correlates with step (7), step-subset (5) of the preferred embodiment.

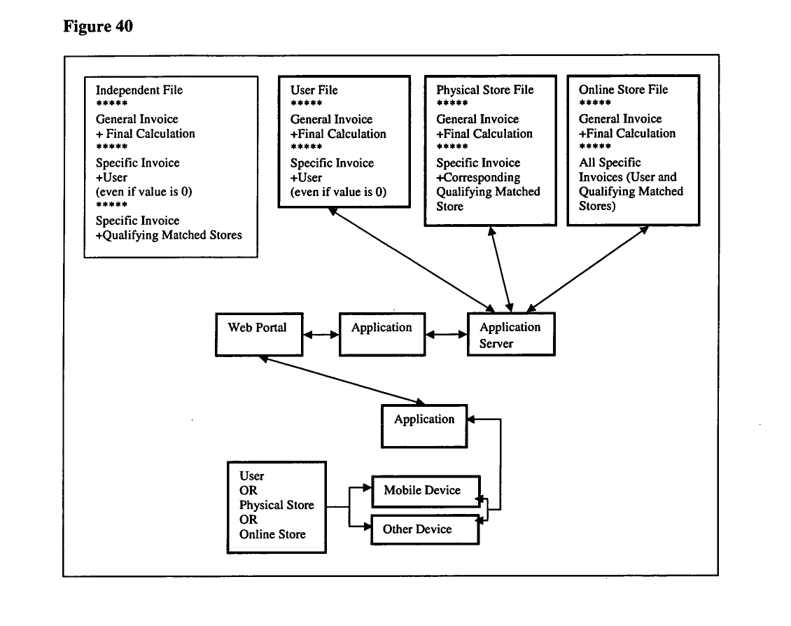

### DETAILED DESCRIPTION OF THE INVENTION

### 1. Description of the Preferred Embodiment

### a. Introduction

This description explains in more detail each of the numbered steps found in the brief summary of the invention. These numbered steps proceed in linear fashion except for step (1), which concerns activities prior to tracking of purchases and may be completed by the User, Physical Store, or Online Store at any time prior to the onset of step (2).

The following written description of the invention allows a person of ordinary skill to construct and utilize the best current embodiment of the method. This description is the best of several currently conceived methods of executing the invention, it is presented to illustrate the invention's general principles, but should in no way be read to limit the potential scope of the invention or the types of possible embodiments. A person of ordinary skill would appreciate that many variations, combinations, and equivalents of the specifically embodied method exist, and therefore the invention is not limited to the above described embodied method, but encompasses all methods within the spirit and scope of the claimed invention. Several examples of alternate embodiments within the spirit and scope of the claimed invention are provided after this first description. Again, these alternate embodiments are not designed to be inclusive, but illustrative of the central concept.

### b. Definitions

Please note that both the Description of the Preferred Embodiment, the Examples of Alternate Embodiments, and the Description of the Drawings Sections, use many terms defined below, which are identifiable due to their capitalization. Reference should be made to these definitions when appropriate. Note that these defined were not used in their “defined” sense in the Abstract, Technical Field, or Description of the Related Art, Sections, because those Sections should be read as a “narrative” and use of defined terms there would complicated the normal reading process. The definitions have also not been used in the Statement of Claim section.

Although definitions are not strictly necessary for purposes of this Specification, in this case they have been made available so as to clarify the meanings of those terms as used in the context of the described invention. Note that the examples of specific stores in these definitions, which existed as of Apr. 27, 2012, are used for illustration purposes only. Also note that these definitions are often used in the above with different suffixes (e.g., “Recorded,” “Recordation,” etc. have the same meaning, modified obviously for their semantic import in accordance with suffix addition, as “Record). Also note that one or several of the definitions may be subject to certain modifications in accordance with one or several of the alternate embodiments in the “Examples of alternate embodiments” section of this Specification.

“Application” —the computer program, or subsets of the same or linked computer programs, or a series of related programs, which executes some part or all of the methods described herein, whether such execution pertains to all or part of the method of the preferred embodiment, the alternate embodiments, or methods not specifically described which encompass the spirit and scope of the all embodiments.

“Application Server” —a Server linked to the Web Portal by the Application, which performs the commonly understood functions of a Server with respect to data submitted from the User, the Physical Store, and the Online Store through the Application, including the filing and storing of electronic information.

“Contact Information” —information provided by the User, Physical Store, and Online Store to the Web Portal in an electronic medium, which identifies that party. Illustrative examples of “contact information” would be an electronic mail address, a physical mailing address, or a phone number. The Contact Information need not be identical for all parties; for example, a User might provide a phone number and an email address, an Online Store might provide only an email address, and so on.
“Experiential Value” —The value reflecting each Matched Store's monetized or monetizable comparative contribution to a Subsequent Online Purchase.
“Final Calculation” —the result of division of the Experiential Value between the User and all qualifying Matched Stores, where a percentage of each qualifying Matched Store's portion of the Experiential Value is allocated to a general pool to satisfy the User's percentage, which is then transferred to a General Invoice and/or Specific Invoice.
“General Invoice” —a readable and uniform means by which the total Experiential Value is delivered from the Independent File to the User, all Matched Stores, and/or the Online Store. This Invoice may contain a subsection containing the Specific Invoice, and may also be either generated for, or contain, the User's percentage of the Final Calculation.
“Independent File” —a file created by the Application on the Application Server, which contains information such as a copy of the list of Matched Stores, and inputs drawn from the files of the Users, Physical Stores, and Online Stores used in the Value Calculation.
“Inventory List” —the known list of items, identifiable via a Product Identifier, indicating which goods are stocked by a Physical Store.
“Matched Store” —any Physical Store whose Inventory List of Product Identifiers has been Recorded and linked by the Application to a Subsequent Online Purchase of an identical Product Identifier, subject to the Value Calculation.
“Mobile Device” —any portable electronic device capable of downloading and/or operating the Application. Preferably, the mobile device is also linked to an internet-based service although this is not strictly necessary.
“Online Store” —any place with a website accessible through the internet which sells goods for wholesale or retail purchase. Amazon.com, and the “online store” of a “chain store” such as Foot Locker are two examples of an “Online Store.”
“Other Device” —any device, other than a Mobile Device, capable of downloading and/or operating the Application. Preferably, the mobile device is also linked to an internet-based service although this is not strictly necessary.
“Other Purchase History” —any purchase of goods made by a User through any method other than a Subsequent Online Purchase.
“Physical Store” —any physical place which sells goods for wholesale or retail purchase in a manner where the goods are made available for a User to physically view, hear, smell, taste, touch, sample, model, or otherwise experience prior to purchase. An independent local grocery, a “chain store” such as Foot Locker, and a stand at a Farmer's Market, are three examples of a “Physical Store.”
“Product Identifier” —a means of marking individual goods for purchase. One example of a “Product Identifier” would be the Universal Product Code (UPC Code), a series of numbers and a barcode affixed to wholesale and retail goods.
“Provisional Matched Store” —any Physical Store whose Inventory List of Product Identifiers has been Recorded and linked by the Application to a Subsequent Online Purchase of a similar Product Identifier, subject to the Value Calculation.
“Record” —the process of identifying a point at which either a User, a User's Mobile Device, and/or Other Device, is Tracked to a Physical Store.
“Register” —the process by which a User, Physical Store, or Online Store downloads the Application.
“Server” —a medium for electronic storage and filing of information, whether based on physical or “cloud-based” software, as the same is commonly understood.
“Specific Invoice” —a readable and uniform means by which each Matched Store's Experiential Value is delivered from the Independent File to the User, the Matched Store appearing on said invoice, and/or the Online Store. The Specific Invoice may exist as a subsection of a General Invoice, and may also be either generated for, or contain, the User's percentage of the Final Calculation.
“Subsequent Online Purchase” —a purchase made by a User at an Online Store which follows the User's Recordation in at least one Physical Store.
“Temp User Calculation File” —a permanent sub-file created in the User's file, which contains a list of data used in the process of “matching” Physical Stores.
“Track” —the process by which a User's physical presence and/or Subsequent Online Purchase is transmitted to the Web Portal for storage on the Application Server from either the User's Mobile Device, or the User's Other Devices linked to the mobile device, the Physical Store's devices, or some other User's Mobile Device or Other Device. This function may involve cross-referencing the User's location against a list of known Physical Store physical locations stored on the Application Server, or any other referencing of the User's location against any other list or compilation of geospatial locations located either on the Application Server or any other Server.
“User” —a human who possesses a Mobile Device or Other Device.
“Value Calculation” —the process by which certain inputs are subjected to a comparison which returns a non-monetized and non-monetizable approximation of the Experiential Value of a User's physical presence in a Matched Store as reflected in a Subsequent Online Purchase.
“Web Portal” —an internet-accessible website linked to the Application Server, accessible to the User, Physical Store, and Online Store, or some combination of the above, which serves as a medium for those parties to download the Application and other information, and to upload certain information to the Application Server.

### c. Preferred Embodiment Description—by Brief Description Steps

### Step (1)—Tracks the Device User's Physical Presence in Physical Stores

All three actors—User, Physical Store, and Online Store—Register by downloading the Application through the Web Portal and providing inputs to the Application Server through the Web Portal.
1. Users—Registration Requirements
   a. Users individually connect to the Web Portal through the internet, either through a Mobile Device or Other Device.
   b. Connected Users download the Application onto their Mobile Device from the Web Portal. To download the Application, Mobile Device Users must provide valid Contact Information, which includes at least either a valid email address or phone number. To be “valid,” Contact Information must be under the direct control of the User. The Application creates a User file on the Application Server and saves the Contact Information to the User file.
   c. The Application will use a locator function similar to that used by applications such as Google Maps, or Yelp, which facilitates the pinpointing of the physical location of the User's mobile device.
   d. The Application will transmit the Mobile Device's physical location through the Web Portal to the Application Server and store the data in the User file.
2. Physical Stores—Registration Requirements
   a. Physical Stores individually connect to the Web Portal, either through a Mobile Device or Other Device.
   b. Connected Physical Stores download the Application onto at least one Mobile Device or Other Device. To install the Application, Physical Stores must provide valid Contact Information, which includes at least valid physical address and email address. To be “valid,” the Contact Information and physical address must be under the direct control of the Physical Store. The Application creates a Physical Store file on the Application Server and saves the valid Contact Information to the Physical Store file.
   c. The Application will use a locator function similar to that used by applications such as Google Maps, or Yelp, which facilitates the pinpointing of the physical location of the Physical Store.
   d. The Application will transmit the Physical Store's physical location through the Web Portal to the Application Serve, where the Application will store the data in the Physical Store file.
   e. The Physical Store will also upload their Inventory List through the Web Portal to the Application Server and store the data in the Physical Store file.
   f. The Application Server will link the stored Inventory List and physical location data. Updates from the Physical Store to the Contact Information will be saved on the Application Server; Updates from the Physical Store to either the Inventory List or physical location will be saved and linked according to the timing of each update. Physical location updates at any point after Registration must be manually uploaded by the Physical Store.
3. Online Stores—Registration Requirements
   a. Online Stores individually connect to the Web Portal, either through a Mobile Device or Other Device.
   b. Connected Online Stores download the Application onto at least one Mobile Device or Other Device. To install the Application, Online Stores must provide valid Contact Information, which includes at least a valid email address. To be “valid,” the Contact Information must be under the direct control of the Online Store. The Application creates an Online Store file on the Application Server and saves the valid Contact Information to the Online Store file.
   c. The Online Store will upload their Inventory List through the Web Portal to the Application Server and store the data in the Online Store file.
   d. The Application Server will link the stored Contact Information and Inventory List. Updates from the Online Store to either the Contact Information or the Inventory List will be saved on the Application Server; updates to the Inventory List will be saved according to the timing of each update.

### Step (2)—Saves the Store's Inventory at the Time the User is Physically Present in the Physical Store

1. When a User enters a Physical Store, the Application will access the Application Server through the Web Portal and, using the locator function and scanning the Physical Store filed on the Application Server, determine whether any of the Physical Store physical locations in the Physical Store files correspond to the current physical location of the Mobile Device.
2. If the Application on the Mobile Device finds any such corresponding physical location, it will Record the User's presence, transmit the Recordation to the Application Server through the Web Portal, and save the Recordation in the User's file.
3. The Application will transfer the most recent copy of the Physical Store's Inventory List through the Application Server to the User file, and simultaneously transfer the User's Recorded physical presence through the Application Server to the Physical Store file, and link User's Recorded physical presence and Physical Store Inventory Lists in both the User and Physical Store files, and save all of the updated files.
4. The Application will store the User's Recorded physical presence on the User's Mobile Device. If the User subsequently visits any other Physical Stores prior to a Subsequent Online Purchase, the Application will store any of these subsequent Recordations in the same manner as for the first Physical Store in terms of modifying the subsequent Physical Store's file and the User's file.

### Step (3)—Tracks the User's Subsequent Online Purchases

1. When the User completes a Subsequent Online Purchase using either the Mobile Device, or any Other Device containing the Contact Information, the Application will send the invoice generated by the Online Store will be sent electronically to both the User and the Web Portal.
2. The Application will store the Subsequent Online Purchase invoice in the User file and the Online Store file.

### Step (4)—Compares the Inventory Lists or Other Lists of a User's Tracked Physical Stores Against the User's List of Online Purchases and Creates a List of “Matched” Stores

1. The Application will analyze the Online Store's invoice from the User's Subsequent Online Purchase which is saved in the User's file on the Application Server, and isolate the Product Identifier of the goods purchased by the User. The Application will create a Temp User Comparison file and place the Product Identifier in that file.
2. The Application will perform a search of that User's Recorded locations in the User's file in the Application Server. The Application will place the User's Recorded locations in the Temp User Comparison File.
3. The Application will then perform a search of the Physical Store Inventory Lists linked to those Recorded locations in the User's file in the Application Server. The Application will place the search results in the Temp User Comparison File.
4. The Application will then return, from the User's Recorded Inventory Lists, a list of Physical Stores whose Inventory Lists have either identical Product Identifiers to those appearing on the invoice from the Subsequent Online Purchase, or Product Identifiers which are “similar” to the Product Identifier listed on the invoice from the Subsequent Online Purchase, as described under the step (5) below. The Physical Stores on the list with identical Product Identifiers become Matched Stores; the Physical Stores on the list with similar Product Identifiers become Qualified Matched Stores, which may in turn become Matched Stores depending on the inputs of step (5) below.
5. The Application will then place the list of Matched Stores and Provisional Matched Stores in the Temp User Comparison File.
6. The Application will create an Independent File in the Application Server, and place a copy of the lists of Matched Stores and Provisional Matched Stores in the Independent File, as well as the other information stored in the Temp User Comparison File.
   Step (5)—Calculates the “Value” of the User's Time in the “Matched” and/or “Unmatched” Stores Against One or Several Variables

Note that there are many possible inputs, or combinations of inputs, by which the Value Calculation can be obtained. All of these Value Calculations may be made subject to the price the User paid for the goods in the Subsequent Online Transaction. The variables in the Value Calculation can be by using, for example, a “score” of 0.00 to 100.00. The Value Calculation is not a final value, but a relational percentage. For example, it could be possible for one Matched Store to have 100.00 of the Value Calculation, or for two Matched Stores to divide the Value Calculation 50.00/50.00 or 70.00/30.00. Although step (5) and step (6) both contain valuations, the two are severable because all inputs in step (5) involve delivery of a relational percentage solely in terms of the value added by Matched Stores; they do not account for how that percentage is divided in its “monetized” form between the Matched Stores and the User. The following illustrations of Value Calculation inputs are only descriptive, not comprehensive. Note also that “Provisional Matched Stores” is not used in step (5); all stores are presumed to “match” subject to the Value Calculation, because thereunder all Provisional Matched Stores will either ultimately qualify or not qualify for a percentage of the Value Calculation. Indeed, all Matched Stores are subject to the same risk of non-qualification for a percentage of the Value Calculation, albeit likely after consideration of different inputs.
1. The Application retrieves some or all of the following data (selected illustrations below) from the User, Physical Store, and/or Online Store files and places it in the Independent File.
2. The Application then performs the Value Calculation from the information in the Independent File, utilizing some, all, or different, inputs, which may include:
I. Temporal Calculations
   a. Time elapsed between a User's Recordation and exit from Matched Store
      i. Single visit to Matched Store—time elapsed
      ii. Single visit to Matched Store—fixed subset of time elapsed
      iii. Single visit to Matched Store—percentage of time elapsed
      iv. Multiple visits to Matched Store—sum of all time elapsed
      v. Multiple visits to Matched Store—sum of fixed subset of all time elapsed
      vi. Multiple visits to Matched Store—percentage of sum of all time elapsed
      vii. Multiple visits to Matched Store—randomized sum of (5)(2)(I)(a)(iv), (5)(2)(I)(a)(v), or (5)(2)(I)(a)(vi)
      viii. Multiple visits to Matched Store—randomized percentage of (5)(2)(I)(a)(iv), (5)(2)(I)(a)(v), or (5)(2)(I)(a)(vi)
   b. Time elapsed between a User's Recordation and Subsequent Online Purchase
      i. Time elapsed
      ii. Fixed subset of time elapsed
      iii. Percentage of time elapsed
      iv. Randomized sum of (5)(2)(I)(b)(i), (5)(2)(I)(b)(ii), or (5)(2)(I)(b)(iii)
      v. Randomized percentage of (5)(2)(I)(b)(i), (5)(2)(I)(b)(ii), or (5)(2)(I)(b)(iii)
   c. Fixed value (no temporal calculation)
   d. Randomized value
II. Comparative Calculations
   a. Comparison of number of Matched Stores visited
   b. Incorporation of values (5)(2)(I)(a)(i)-(viii), inclusive
   c. Comparison of number of distinct Product Identifiers in each Matched Store's Inventory List
   d. Comparison of selected number of distinct Product Identifiers in each Matched Store's Inventory List
   e. Comparison of percentage of Matched Stores visited weighted by (5)(2)(II)(b) or (5)(2)(II)(c)
   f. Fixed value (no comparative calculation)
   g. Randomized value
III. User-History Calculations
   a. Comparison of a single User's Subsequent Online Purchase History of specific Product Identifier
   b. Comparison of a single User's Subsequent Online Purchase History of subset of Product Identifiers
   c. Comparison of multiple Users' Subsequent Online Purchase History of specific Product Identifier
   d. Comparison of multiple Users' Subsequent Online Purchase History of a subset of specific Product Identifiers
   e. Comparison of a single User's Subsequent Online Purchase History and Other Purchase History of specific Product Identifier
   f. Comparison of a single User's Subsequent Online Purchase History and Other Purchase History of subset of Product Identifiers
   g. Comparison of multiple Users' Subsequent Online Purchase History and Other Purchase History of specific Product Identifier
   h. Comparison of multiple Users' Subsequent Online Purchase History and Other Purchase History of a subset of specific Product Identifiers
   i. Fixed value (no User history calculations)
   j. Randomized value
IV. Item Class Calculations
   a. Comparison of established or estimated experiential value of a specific Product Identifier
   b. Comparison of established or estimated experiential value of a subset of specific Product Identifiers
   c. Comparison of established or estimated experiential value of a percentage of specific Product Identifiers
V. Geographical Calculations
   a. Comparison of Matched Stores within specific geographical radius
   b. Comparison of Matched Stores and “unmatched” stores within specific geographical radius
   c. Comparison of Matched Stores within specific boundary (city, state, zip code, etc.)
   d. Comparison of Matched Stores and “unmatched” stores within specific boundary (city, state, zip code, etc.)
VI. Other Calculations
   Step (6) Compares all or a Percentage of this Valuation Against a User's Subsequent Online Purchase and Converts the Comparison into a Monetized or Monetizable Form
1. After the Value Calculation is performed, the Application saves the Value Calculation in the Independent File on the Application Server.
2. The Application then retrieves the Subsequent Online Purchase invoice sent from the Online Store to the User from the Online Store's file and places it in the Independent File.
3. The Application derives the purchase price of the Subsequent Online Purchase from the Online Store's invoice to the User in the Independent File.
4. The Application then links the Value Calculation and the total purchase price of the Subsequent Online Purchase in the Independent File.
5. The Application then compares the linked Value Calculation and the purchase price of the Subsequent Online Purchase. The value returned by this comparison is the Experiential Value. The Experiential Value is then saved in the Independent File.
6. The Application then divides the Experiential Value between all qualifying Matched Store's according to each qualified Matched Store's contribution to the purchase price of goods included in the Subsequent Online Purchase.
7. The Application then saves the divided Experiential Values, i.e., the qualifying Matched Store Experiential Value contributions, in the Independent File on the Application Server.

### Step (7) Remits all or a Percentage of the Monetized or Monetizable Valuation to Either the User, the Physical Store, or Both

1. The Application divides the total Experiential Value between the User (as determined by Recordation) and all qualifying Matched Stores according to each qualifying Matched Store's contribution to the total Experiential Value, and taking an appropriate percentage from each qualifying Matched Store to meet the User's percentage, if any. The divided values reflecting the User's percentage of the Experiential Value, and each qualifying Matched Store's adjusted percentage of the Experiential Value, become the inputs of the Final Calculation. The Application saves a copy of the Final Calculation in the Independent File.
2. The Application creates a General Invoice, transfers the Final Calculation to the General Invoice, and saves a copy of the General Invoice to the Independent File.
3. The Application then generates Specific Invoices for each qualifying Matched Store, as well as the User, from the information from the Final Calculation on the General Invoice, and saves a copy of each Specific Invoice to the Independent File.
4. The Application then transmits the General Invoice to the files of the User, Online Store, and any Physical Stores which correspond with a qualifying Matched Store; these transmissions reflect the User and qualifying Matched Store names appearing on the General Invoice. The Application also transmits Specific Invoices to the User file and the aforementioned Physical Stores; again, these transmissions reflect the User and qualifying Matched Store names appearing on each Specific Invoice. The Application also transmits all Specific Invoices to the Online Store file.
5. The Application makes the General Invoice and Specific Invoices stored in the User, Physical Stores, and Online Store files available for each of those parties to view or download through the Web Portal, to either a Mobile Device or Other Device. Each party can view or download only those General Invoice and Specific Invoices which exist in that party's file.

### 2. Description of the Illustrated Alternate Embodiments

The alternate embodiments listed below are designed as illustrative, not comprehensive. For the sake of ease, they have been roughly correlated with steps (1) through step (7) above to the extent that each illustrated alternative embodiment reflects a change in that particular step. Note that the numbered paragraphs do not correspond with the numbering within each of the steps listed above in the Description of the Preferred Embodiment.

### Step (1)—Tracks the Device User's Physical Presence in Physical Stores

1. The preferred embodiment does not make the User's physical location data, the Physical Store's Inventory List, or the Online Store's Inventory List available to any of the other parties through the Web Portal, but protects the privacy of all three parties by withholding the data until a User actually makes a Subsequent Online Purchase which subjects specific User, Physical Store, and Online Store data to creation of the Independent File in step (4), and the Value Calculation in step (5). However, an alternate embodiments could make (a) a User's physical location data available, through the Web Portal, to either the Physical Store, the Online Retailer, or both, regardless whether the User makes a Subsequent Online Purchase; (b) a Physical Store's Inventory List available, through the Web Portal, to either the User, the Online Retailer, or both, regardless whether the User makes a Subsequent Online Purchase; (c) an Online Store's Inventory List available, through the Web Portal, to either the User, the Physical Store, or both, regardless whether the User makes a Subsequent Online Purchase; or (d) some combination of the above. Sharing of any of this data would advance the analytical abilities of the valuation, although there is a corresponding decrease in privacy for any party whose data is shared. Because Physical Stores and Online Stores naturally display goods displayed in their Inventory Lists to the public for sale, the intrusion on their privacy appears minimal and even beneficial; however, the infringement on a User's privacy is far more pronounced, as the Application provides a running list of what Physical Stores they have visited. Ultimately, any or all of these parties could be incentivized to display this data through a voluntary action, available after downloading the Application, which simultaneously rewards that party which shares data over the Web Portal with a greater percentage of the Final Calculation. It might also be possible to suspend the requirement that the Online Store provide an Inventory List altogether and to perform the valuation upon transfer of an Invoice to the User and the Web Portal, although this might entail greater difficulties in programming the Application for differences in Online Store invoicing systems.
2. Note that there is no actual need for Physical Stores to use the Application's locator function to return their physical location for upload; this could be accomplished by simply uploading a physical address, which is already done. The use of the locator function, in addition to uploading a physical address, is designed to serve as a check against abnormalities or human error in entering the wrong address. In the preferred embodiment, the fact that subsequent updates to the Physical Store's physical location must be entered manually is a further check against incongruities that could occur by continued use of the locator function. However, if less surety is needed, an alternate embodiment would dispense of the Physical Stores' use of the Application's locator function. Obviously, for the locator function to return the same result, the Physical Store employee Registering the Physical Store would have to use a Mobile Device or Other Device which is actually located in the store during Registration.
3. Note also that in the preferred embodiment neither the User, Physical Store, nor Online Store need be connected to the web portal at all times, but must simply have Registered with the Web Portal and downloaded the Application. After Registration the Physical Store's interaction with the Web Portal, at a minimum, must consist of uploading its Inventory List. Similarly, after Registration an Online Store's interaction with the Web Portal, at a minimum, must consist of transmitting any and all invoices of a User's Subsequent Online Purchases.
4. Note also that the “physical location” saved for the User at Registration is only the initial location when the User Registers. Subsequent locations would have to be subject to continual cross-referencing to determine whether the User's physical location matched that of a Physical Store.
5. For Online Stores it is not strictly necessary to either use the locator function or upload physical address data, although such could be useful in ultimately making the Value Calculation, especially if a particular Online Store is actually a large “hybrid” business and wishes to adjust for its own physical presence, or otherwise return geographical information which relates to its own physical location. Alternatively, the Application could derive the shipping address from the invoice sent from the Online Store to the User in connection with the Subsequent Online Purchase.

### Step (2)—Saves the Store's Inventory at the Time the User is Physically Present in the Physical Store

1. While the preferred embodiment saves a copy of the linked User's Recorded physical presence data and Physical Store Inventory Lists in the files of both the User and the Physical Store, this need not occur. This linked information could be stored in only one of the two parties' files, or in another file not associated with either the User or the Physical Store at the time of Registration, such as the Independent File. Although it is not contemplated that either party would have access to the linked data at any point prior to the Final Calculation (or at least the Value Calculation), this could be modified as parties find it necessary. In the preferred embodiment, the Recordation is saved to the User's file before transfer of the Physical Store's Inventory List because this serves as a check against the possibility that some issue with the Physical Store's Inventory List makes it impossible to transfer the Inventory List to the User's file immediately after Recordation.
2. Another embodiment of the method involves a difference how the User is Tracked. In this embodiment the User's Mobile Device does not use a “locator” function. Instead, each Physical Store installs a device or scanner capable of reading marked information on the User's Mobile Device and transmitting it either over the internet to the Application Server through the Web Portal. Here, Recordation of the User's Mobile Device occurs when the Mobile Device interacts with the Physical Store's own device or scanner. The User could scan his or her Mobile Device or subject his or her Mobile Device for scanning by the Physical Store once after entry to the Store, or twice to mark entry or exit, depending on whether the Value Calculation contemplates a temporal calculation as reflected in step (5)(3)(I). Therefore, there would be no specific need for the Application to utilize a locator function similar to Google Maps or Yelp for purposes of Recordation, although installation of such a function could serve other useful purposes.
3. Another embodiment, related to the one described in paragraph (2) immediately above, eliminates the necessity for the User to either Register as well as Record. In this embodiment, the Physical Store's own device or scanner could collect information from the User's Mobile Device and save this information into its own file on the Web Portal. Afterwards, the Application would search the Product Identifiers of Subsequent Online Purchase invoices against all Physical Store files containing either identical or similar Product Identifiers and Contact Information from a User which matched that contained on the Subsequent Online Purchase invoice. Here, compensating the User in the Final Calculation is not impossible, but could prove problematic, and so Physical Stores would have to incentivize the User to subject his or her Mobile Device to in-store scanning by some other means. This embodiment could result in far less efficient searching, but effectively reduces the transaction as between the Physical Store and the Online Store without the need to consider additional User variables or induce Users to register. Therefore, it could be implemented far more quickly than otherwise.
4. Another embodiment of the method involves a difference in “matching” the Product Identifiers of the Physical Store to the Subsequent Online Purchase. In this embodiment the User utilizes a camera function of his or her Mobile Device to capture an image of the Product Identifier (most likely, the UPC barcode) in the store. The Application on the User's Mobile Device would then translate the Product Identifier into a usable format. Instead of correlating the Physical Store's Inventory List with the User's Recordation, the Application would correlate only the “scanned” and converted Product Identifier or “similar” Product Identifiers to the User's Recordation. This embodiment would liberate Physical Stores from the burden of uploading their Inventory Lists onto the Application Server through the Web Portal.
5. Another embodiment would combine the functions of the two embodiments in paragraphs (2) and (4) above. In this embodiment, the User “scans” his or her Mobile Device with a Physical Store's own scanner or device, and also utilizes the Mobile Device's camera function to capture an image of the Product Identifier (most likely, the UPC barcode) in the store. This embodiment would permit the Application to dispense with either a locator function or a “matching” calculation. This embodiment could drastically reduce the amount of data needed to be stored on the Application Server, both with respect to User physical store Recordation and Physical Store Inventory Lists; it would also make “matching” calculations far simpler.
6. Another embodiment would dispense with the User's Mobile Device altogether, and allow the User to physically provide contact information to the Physical Store, either orally or through the Physical Store's own device, which would Record the User and Track Subsequent Online Purchases. This method would involve minimal programming, although the benefits of automation would be largely lost.
7. Note that in order to protect User privacy and to save storage space, the preferred embodiment does not save any of the User's physical locations in the User file, except for the User's initial physical location at the time of Registration, and for Recordations. However, an alternate embodiment could save a list of all or some tracking data in the User file for some length of time, or permanently. This could be especially important for an alternate embodiment in which the User is able to dispense with continual tracking, and manually “updates” his or her Mobile Device from time to time.
8. The preferred embodiment indicates that the Application will store a copy of all user Recordations on the User's Mobile Device. However, an alternate embodiment could forego this step in order to decrease the number of required computer operations, as well as to protect user privacy.

### Step (3)—Tracks the User's Subsequent Online Purchases

1. As noted above in one of the alternate embodiments for step (2), the preferred embodiment does not Track the User's subsequent use of a Mobile Device or Other Device between the point of Recordation to the point of the Subsequent Online Purchase, except when other Recordations occur which are placed in the User File. Similarly, the Application in the preferred embodiment lacks the capacity to Track every online purchase initiated with the User's Mobile Device or Other Device, whether a Subsequent Online Purchase or not; instead, these steps are triggered at the time the Online Store generates a Subsequent Online Purchase invoice and sends it to the User and the Application Server through the Web Portal. This results in fewer and more precise matching and valuation initiations; moreover, if the number of goods whose Product Identifiers are marked for potential matching and valuation is limited by either User, Physical Store, or Online Store, greater privacy of User data will be ensured. An alternate embodiment would require the Mobile Device to update the Application Server through the Web Portal of all Subsequent Online Purchases and subject each of them to matching and valuation in steps (4) and (5), regardless of any adjustments to the number of goods whose Product Identifiers are ultimately marked for potential matching and valuation. This would again give more comprehensive information, but might result in considerable loss of privacy. Provision of this information by the User could be made subject to voluntary incentivized readjustment of the Final Calculation. Further, while the invoice generated by the Online Store for the Subsequent Online Purchase is designed to be saved to the User's file and the Online Store's file for privacy reasons, and does not save a copy to the Physical Store's file before performing steps (4) and (5), an alternate embodiment could also store a copy of the invoice in Physical Stores' files as well, and make allow the invoice to be viewable on the Web Portal to the Physical Store.
2. Step (3) indicates that the Online Store's invoice is sent to the generalized “User,” and not the User's Mobile Device or Other Device, due to the fact that such particulars could pose needless difficulties with individualized Online Store invoicing and billing systems. In fact there is no need for the Online Store to send its invoice to this generalized “User” at all; all that is required is to send a copy of the invoice to the Web Portal. However, difficulties in programming might be overcome with respect to some invoicing systems, and certainly other security protections could be adopted, if the Online Store's Subsequent Online Purchase invoice was sent to both the Web Portal and either or both of the User's Mobile Device or Other Device. An alternate embodiment could account for this change.
3. An alternate embodiment could find an Online Store manually submitted the invoices to the Web Portal without use of the Application. This, however, might prove unduly burdensome, although it would sidestep what at likely to be considerable programming challenges.

### (4)—Compares the Inventory Lists or Other Lists of a User's Tracked Physical Stores Against the User's List of Online Purchases and Creates a List of “Matched” Stores

1. As with illustrated alternate embodiments step (3), it is possible for the Application to make a list of Matched Stores available on the Web Portal to the User, Physical Store, and Online Store. For the same privacy reasons as detailed there, such availability does not exist in the preferred embodiment; also similar to the manner detailed above, this information could be made available through a voluntary incentivized readjustment of the Final Calculation.
2. Because step (4)'s “matching” function depends in part on pre-determined valuation issues addressed primarily in step (5)'s Value Calculation (i.e., matching a single Product Identifier, or a predetermined list of “similar” identifiers), it is possible to limit the number of Matched Stores by adding other predetermined variables from the Value Calculation, such as geographical location, time between User Physical Store Registration and Subsequent Online Purchase, etc. However, adding too many variables to step (4) diminishes the analytical potential of either the Value Calculation, Experiential Value, or Final Calculation, and since the ultimate aim of the method is to determine the value of a User's time in physical space as a product of some actual future purchase of goods, allowing for predetermined adjustment of the Product Identifier in step (4) is the most viable (though certainly not the only possible) means of returning a list of Matched Stores.
3. Step (4) creates a Temp User Calculation File, a sub-folder within the User's File, for purposes of filing the information used in the Matched Store calculation. The word “Temp” in the description is meant to reflect the fact that the value of the data it contains is temporary—i.e., only after Physical Stores become Matched Stores can a Value Calculation occur—not that the data in the Temp User Calculation File will be deleted after Matching occurs. Although it would be useful to have some pieces of the data contained in this file, such as the Product Identifiers, in isolation, an alternate embodiment could nevertheless delete this data in case storage space becomes an issue.
4. Step (4) also creates an Independent File for the Matched Stores which exists independently of the User, Physical Store, and Online Store files. Into this new file the Application puts the information by which the Value Calculation is performed. The creation of a separate file for performing the Value Calculation is merely presumed to make the Application run more efficiently and will not involve unnecessary “invasion” into the User's particular file, but ultimately there is no reason why Value Calculations could not be simultaneously run from the Temp User Calculation File, or files attributed to the Physical Store, or Online Store. Creation of a separate file allows flexible transfer of some, but not all, of the information from the Temp User Calculation File to the Independent File, which alternate embodiments could reflect in order to increase processing speed or reduce complexity in structuring the Value Calculation.
   Step (5)—Calculates the “Value” of the User's Time in the “Matched” and/or “Unmatched” Stores Against One or Several Variables
1. As mentioned above, there are a great number of alternate variables that may be considered when performing the Value Calculation, which would be obvious to someone practiced in the art, and will not be elaborated on here. One possible embodiment, however, is to provide the User a means of populating the Application Server, through the Web Portal, with an “Other Purchase History,” comprising a list of goods purchased through any other method than a Subsequent Online Purchase, which can be factored into the Value Calculation. This type of voluntary offering of information is anticipated to be both burdensome and difficult to handle with any analytical accuracy, but could any indeterminacy could be effectively policed by either the Physical Store or the Online Store by limiting the types of purchases from a User's Other Purchase History which can become inputs in the Value Calculation.
2. As noted above in step (4), the preferred embodiment creates an Independent File for the Matched Stores which exists independently of the User, Physical Store, and Online Store files. As noted above, if no Independent File is created, Value Calculations can be performed in any and all of the User, Physical Store, and Online Store files by gathering information from the User, Physical Store, and Online Store files.
3. The preferred embodiment subjects each calculation of the value to all of the separate illustrated calculation steps (and others not illustrated), before saving the Value Calculation. Alternate embodiments could save each discrete calculation performed, and then compare these discrete values, before arriving at a Value Calculation.
   Step (6)—Compares all or a Percentage of this Valuation Against a User's Subsequent Online Purchase and Converts the Comparison into a Monetized or Monetizable Form
1. As noted above in step (4) and step (5), the preferred embodiment creates an Independent File for the Matched Stores which exists independently of the User, Physical Store, and Online Store files. If no Independent File is created and Value Calculations are performed in any and all of the User, Physical Store, and Online Store files, there is no need for operation of this step in the Independent File.

### Step (7)—Remits all or a Percentage of the Monetized or Monetizable Valuation to Either the User, the Physical Store, or Both

1. An alternate embodiment would dispense with step (7) and return only the Experiential Value (and perhaps step (6) as well, and return only the Value Calculation). This embodiment has particular utility as a diagnostic tool, and would prove useful if particularly challenging obstacles arise regarding integration of the General Invoice as to Physical Stores, Online Stores, or Users. Incentives for User participation in this scenario could include an overall “discount” on all items purchased from a particular Physical Store or Online Store, or the opportunity to enter randomized drawings for discounts or prizes awarded by either the Physical Store or Online Store, or some other method. Further, it is not absolutely necessary to remit both a General Invoice and a Specific Invoice to each Matched Store; instead, only a Specific Invoice need be generated for each Matched Store.
2. Note that although a User may not qualify for any portion of the Experiential Value, their percentage (even if 0) is reflected on the General Invoice and a Specific Invoice is generated for them to be saved in their file. This reflects the fact that the User is the central actor in this transaction, and the knowledge of which Subsequent Online Purchases had no Experiential Value in and of itself has value. An alternate embodiment could, however, exclude this step for the sake of efficiency.

What is claimed is:

1. A method, embodied in a computer program or series of computer programs available on a web portal linked to a server, which is downloaded and installed on a physical user's internet-accessible mobile device or other device, a physical store's internet-accessible device, and an online store's internet-accessible device; which saves specified physical user, physical store, or online store contact information, including but not limited to name, email address, physical address, phone number, into a file created on the server designated for that entity; allows the physical store and online store to upload and update inventory lists of current products sold, the geographical locations of their businesses, and website urls maintained into that user's file on the server; tracks the physical user's mobile device's physical presence using a geographic locator function; saves the mobile device's physical location at selected intervals; uploads the location information to the server; and saves the location information in the physical user's designated file.

2. The method of claim 1, where the computer program or series of computer programs is downloaded by a physical user's non-mobile device and subsequently transferred to the physical user's mobile device, or downloaded by a physical user's mobile device and subsequently transferred to the physical user's non-mobile device.

3. The method of claim 1, where the physical user is allowed to exclude certain geographic coordinates or locations from upload, or the physical user's physical location is only uploaded when the physical user's mobile device enters specific geographic coordinates.

4. The method of claim 1, where the physical store or online store uploads only a selection of its current inventory lists, physical locations, or website urls maintained.

5. A method, embodied in a computer program or series of computer programs, for comparing a physical user's mobile device's geographic location of claim 1 against a list of physical store geographic locations of claim 1 as this information is stored on a server linked to a web portal described in claim 1; making a positive correlation between the geographical locations of the mobile device and any physical stores; saving a record of any positive correlations in files designated for the physical store and the physical user; tracking the physical user's subsequent internet history in browsing for and purchasing a specified good or service from an online store described in claim 1 by identifying the specified good or service purchased from any maintained website urls saved in the online store's file on the server; generating an invoice reflecting the origin of the sale, as well as the price, quantity and nature of the good or service purchased; transmitting the invoice through a web portal to a server, and storing the invoice in files designated for either or both the online store and the physical user; creating a designated file on a server; placing information related to the type of good or service purchased by a physical user from an online store into the designated file; searching the physical user's mobile device's stored geographic locations on the server; placing these locations into the designated file; correlating these locations with the stored physical locations of any physical stores located on the server as described in claim 1; evaluating the stored inventory lists of any correlated physical stores; saving into the designated file a list of all correlated physical stores whose stored inventory lists contain an identical or similar good or service to the good or service identified as purchased by the physical user from the online store; and then transferring all information from the designated file into a new file.

6. The method of claim 5, where the comparison between the physical user's mobile device's geographic location of claim 1 against a list of physical store geographic locations of claim 1 is made manually by either the physical user, the physical store, or both, while the physical user's mobile device is actually present in or in the proximity of the physical store, or at some point after such physical presence or proximity first occurs.

7. The method of claim 5, where the evaluation of stored inventory lists of any correlated physical stores is predicated upon satisfaction of pre-determined criteria such as the geographic distance between physical user's mobile device, the physical store, or the online store; or the time elapsed between the physical user's mobile device's presence in a physical store and the user's subsequent online purchase described in claim 5; and excluded or modified as necessary.

8. The method of claim 5, where the physical user's mobile device browsing history is also tracked even if no subsequent online purchase is made.

9. The method of claim 5, where no new file is created and all information is saved in the files of the physical user, the physical store, and the online store as each is described in claim 1.

10. A method, embodied in a computer program or series of computer programs, for gathering all information saved in the new file described in claim 5; obtaining additional information from physical user's file, the physical store's file, and the online store's file described in claim 1; generating a numerical value reflecting a physical user's presence in a physical store based upon: temporal calculations; comparative calculations between specified physical stores; calculations involving a physical user's good or service purchase history; calculations involving the type of good or service purchased by the physical user; calculations including the location of the good or service in a physical store which the physical user subsequently purchased from an online store; or other calculations; and saving the result of the calculation in the new file described in claim 5.

11. The method of claim 10, where the numerical value generated by the calculation reflects only some, but not all, categories of calculations described therein.

12. The method of claim 10, where every discrete step taken in performing any and all calculations described therein is saved in either the new file or another file.

13. A method, embodied in a computer program or series of computer programs, for retrieving the invoice generated from the physical user's online purchase described in claim 5 from the files or either or both the physical user described in claim 1 and the online store described in claim 1; disaggregating the total purchase price from the invoice; separating the total purchase price to specify sales tax, shipping costs, and total good or service costs of the goods or services sold, further dividing the separated purchase price amounts by the quantity of good or service sold which is reflected on the invoice; comparing that disaggregated purchase price against the calculation from claim 5 which was saved in the new file described in claim 5; deriving a new value from the comparison; saving the new value in the new file described in claim 5; dividing the new value between a number of appropriate physical stores; saving each division of the new value in the new file described in claim 5; apportioning the divided values between all appropriate physical stores and the physical user described in claim 1 whose subsequent online purchase resulted in the correlation of claim 5 and the calculation of claim 10; saving all apportioned value results in the new file described in claim 5; generating a standardized general invoice from the apportioned value results, which contains all results designated for the physical user and any physical stores; saving this general invoice in the new file described in claim 5, the file of the physical user described in claim 1, the file of any physical stores described in claim 1 that satisfied the conditions of claim 5 and claim 10, and the online store described in claim 1 which satisfied the conditions of claim 5 and claim 10; generating from the information on the general invoice specific invoices designated for the specified physical user and for each appropriate physical store; transferring the apportioned value result for either the physical user or the physical store, and only that value result, onto the specific invoice generated for that user or physical store; saving a copy of each specific invoice in the new file described in claim 5, and in the online store's file described in claim 1, and saving each specific invoice containing either a specific physical user's or physical store's apportioned value result in that specific physical user or physical store's file described in claim 1; and allowing each physical user, physical store, and online store to which general and/or specific invoices were saved to their respective files to view and download the invoices saved to their respective files by accessing the same through the web portal linked to a server described in claim 1.

14. The method of claim 13, where total purchase price is made subject to comparison against the calculation of claim 10 and saved in the new file described in claim 5 without first separating that purchase price to specify sales tax, shipping costs, and/or total good or service costs, and/or further dividing any separated purchase price amounts by the quantity of good or service sold as reflected on the invoice.

15. The method of claim 13, where the new value derived from the comparison is correlated with and represented by any recognizable means of currency, exchange, language, or form.

16. The method of claim 13, where no general invoice is created and all information for the specific invoices is derived directly from the apportioned valued results saved in the new file described in claim 5 or in the files of the physical user, the physical store, and the online store described in claim 1; or where no specific invoices are generated and the general invoice is substituted in the place of all specific invoices.

17. The method of claim 13, where only specific invoices are generated for the physical user, the physical store, or the online store described in claim 1, or one or several of these entities, and the general invoice is substituted in the place of the specific invoice for one or several of those entities.

18. The method of claim 13, where all invoices, or only several of them, are not made automatically downloadable or viewable, or are subsequently excluded from download or view by action of the physical user, the physical stores, the online store described in claim 1, or excluded by the manual or automatic intervention of an entity which is not a physical user, a physical store, or an online store.

19. The method of claim 13, where no new files are created and all relevant calculations are saved in the new file described in claim 5, or the file or files of the physical user, physical store, or online store described in claim 1.

20. The aggregate method of claims 1, 5, 10, and 13, where performance of any step or process of any claimed method, or access to any calculation or product of any claimed method, is made subject to manual or automatic performance or access by an entity which is not a physical user, physical store, or online store described in claim 1.

21. The aggregate method of claims 1, 5, 10, and 13.
